(19) United States
(12) Patent Application Publication
(10) Pub. No.: US 2019/0217713 A1
(43) Pub. Date: Jul. 18, 2019

(54) CHARGING PORT HEATER

(71) Applicant: Ford Global Technologies, LLC, Dearborn, MI (US)

(72) Inventors: Stuart C. Salter, White Lake, MI (US); Bill Grewal, Ann Arbor, MI (US); Paul Kenneth Dellock, Northville, MI (US); James J. Surman, Clinton Township, MI (US)

(21) Appl. No.: 15/872,356

(22) Filed: Jan. 16, 2018

(51) Int. Cl. B60L 11/18; B60L 5/02; H05B 1/02

(52) U.S. Cl. CPC B60L 11/1818; H05B 1/0236; B60L 5/02

(57) ABSTRACT

One aspect of this disclosure relates to an electrified vehicle including a heater element at least partially insert-molded with a charging port. In another aspect of this disclosure, the charging port includes a polymer material having a thermal conductivity greater than about 10 watts per meter-Kelvin (W/m-K). A method is also disclosed.

### TECHNICAL FIELD

This disclosure relates to a heater for a charging port of an electrified vehicle.

### BACKGROUND

The need to reduce automotive fuel consumption and emissions is well known. Therefore, vehicles are being developed that reduce or completely eliminate reliance on internal combustion engines. Electrified vehicles are one type of vehicle being developed for this purpose. In general, electrified vehicles differ from conventional motor vehicles because they are selectively driven by electric machines. Conventional motor vehicles, by contrast, rely exclusively on an internal combustion engine to propel the vehicle. Example electrified vehicles include hybrid electric vehicles (HEVs), plug-in hybrid electric vehicles (PHEVs), fuel cell vehicles (FCVs), and battery electric vehicles (BEVs).

Some electrified vehicles charge their battery using power from an external power source, such as a grid power source. Typically, power flows to the battery via electric vehicle supply equipment (EVSE), such as a cord set. In particular, power flows to the battery when a plug of the cord set is coupled to a charging port of the electrified vehicle.

### SUMMARY

An electrified vehicle according to an exemplary aspect of the present disclosure includes, among other things, a charging port having a heater element at least partially insert-molded with the charging port.

In a further non-limiting embodiment of the foregoing electrified vehicle, the charging port includes a polymer material molded over the heater element.

In a further non-limiting embodiment of any of the foregoing electrified vehicles, the polymer has a thermal conductivity of greater than about 10 watts per meter-Kelvin (W/m-K).

In a further non-limiting embodiment of any of the foregoing electrified vehicles, the polymer has a thermal conductivity of about 14 watts per meter-Kelvin (W/m-K).

In a further non-limiting embodiment of any of the foregoing electrified vehicles, the heater element includes at least one resistive heater wire.

In a further non-limiting embodiment of any of the foregoing electrified vehicles, the at least one resistive heater wire is at least partially insert-molded into a socket of the charging port.

In a further non-limiting embodiment of any of the foregoing electrified vehicles, the heater element includes a plurality of resistive heater wires, and each of the plurality of resistive heater wires are spaced-apart from one another.

In a further non-limiting embodiment of any of the foregoing electrified vehicles, each of the plurality of resistive heater wires are arranged in parallel relative to one another.

In a further non-limiting embodiment of any of the foregoing electrified vehicles, each of the plurality of resistive heater wires are arranged beneath an exterior surface of the charging port.

In a further non-limiting embodiment of any of the foregoing electrified vehicles, two of the plurality of resistive heater wires are at least partially insert-molded into a socket of the charging port.

In a further non-limiting embodiment of any of the foregoing electrified vehicles, the electrified vehicle includes a controller and a current source electrically coupled to the controller and to the heater element. The current source is responsive to instructions from the controller to selectively activate the heater element.

An electrified vehicle according to another exemplary aspect of the present disclosure includes, among other things, a charging port having a heater element. The charging port includes a polymer having a thermal conductivity of greater than about 10 watts per meter-Kelvin (W/m-K).

In a further non-limiting embodiment of any of the foregoing electrified vehicles, the polymer has a thermal conductivity of about 14 watts per meter-Kelvin (W/m-K).

In a further non-limiting embodiment of any of the foregoing electrified vehicles, the heater element includes at least one resistive heater wire insert-molded into the charging port.

In a further non-limiting embodiment of any of the foregoing electrified vehicles, the at least one resistive heater wire is at least partially insert-molded into a socket of the charging port.

A method according to an exemplary aspect of the present disclosure includes, among other things, heating a charging port of an electrified vehicle by activating a heater element insert-molded into the charging port.

In a further non-limiting embodiment of the foregoing method, the charging port includes a polymer molded over the heater element, the polymer has a thermal conductivity of greater than about 10 watts per meter-Kelvin (W/m-K), and when a plug is coupled to the charging port, the heater element heats the plug via the charging port.

In a further non-limiting embodiment of any of the foregoing methods, the step of heating the charging port is performed only when a precipitation sensor is activated.

In a further non-limiting embodiment of any of the foregoing methods, the step of heating the charging port is performed only when a temperature falls below a predetermined threshold.

In a further non-limiting embodiment of any of the foregoing methods, the temperature is determined based on an output from at least one of a vehicle body temperature sensor and a microprocessor adjacent the charging port.

### BRIEF DESCRIPTION OF THE DRAWINGS

FIG. 1 is a partially schematic side view of an example electrified vehicle.

FIG. 2 illustrates an example charging port and heater element.

FIG. 3 is a cross-sectional view taken along line 3-3.

FIG. 4 is a flow chart representative of an example method.

### DETAILED DESCRIPTION

One aspect of this disclosure relates to an electrified vehicle including a heater element at least partially insert-molded with a charging port. The heater element is selectively activated to prevent the buildup of ice and snow adjacent the charging port. The disclosed charging port is relatively easily manufactured and operates efficiently. In another aspect of this disclosure, the charging port includes a polymer material having a thermal conductivity greater than about 10 watts per meter-Kelvin (W/m-K), which is significantly higher than that of most polymers. The increased thermal conductivity serves to heat elements that are connected to the charging port, such as a plug of a cord set, which is particularly useful when charging for extended periods outdoors during wintery conditions.

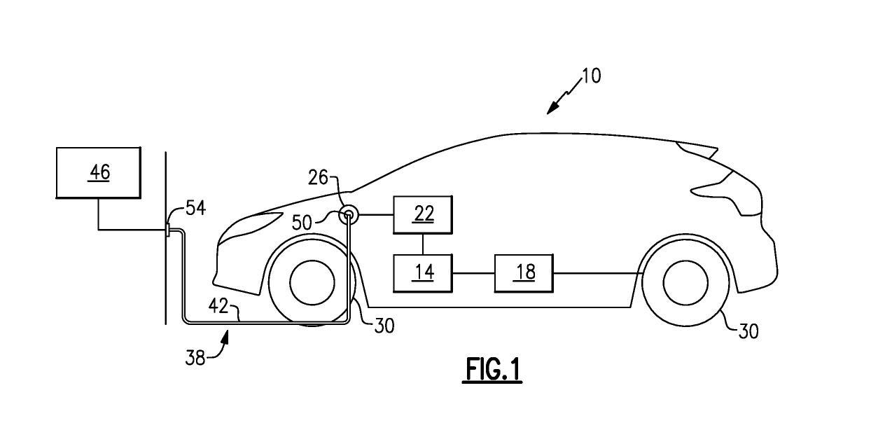

Referring to the drawings, FIG. 1 illustrates an example electrified vehicle 10. The electrified vehicle 10 includes a battery 14 (e.g., a battery pack), an electric machine 18, a controller 22, a charging port 26, and wheels 30. The electric machine 18 is configured to receive electric power from the battery 14, and to convert that electric power to torque to drive the wheels 30. The battery 14 is a relatively high voltage traction battery in one example.

In FIG. 1, an example set of electric vehicle supply equipment (EVSE) 38 is engaged with the charging port 26. The EVSE 38 includes a cord set 42 in this example. The cord set 42 is a type of EVSE 38 that is portable. Other examples of EVSE 38 can include fixed residential or commercial charging stations. For purposes of this disclosure, EVSE 38 includes any device separate from the electrified vehicle 10 that can be used to charge the battery 14.

To charge the battery 14, the cord set 42 electrically couples the battery 14 to a power source outside the vehicle 10, such as a grid power source 46. The cord set 42 includes a plug 50, which includes a handle, to connect the cord set 42 to the charging port 26. The cord set 42 includes another plug 54 to connect the cord set 42 to the grid power source 46. In FIG. 1, the plug 50 is received in a socket of the charging port 26, which allows power to flow from the grid power source 46 to the battery 14.

It should be understood that the controller 22 could be part of an overall vehicle control module, such as a vehicle system controller (VSC) or body control module (BCM). Alternatively, the controller 22 may be a stand-alone controller separate from the VSC and the BCM. Further, the controller 22 may be programmed with executable instructions for interfacing with and operating the various components of the electrified vehicle 10. The controller 22 additionally includes a processing unit and non-transitory memory for executing the various control strategies and modes of the electrified vehicle 10.

The electrified vehicle 10 is an all-electric vehicle in this example, such as a battery electric vehicle (BEV). In other examples, the electrified vehicle 10 is a plug-in hybrid electric vehicle (PHEV), which selectively drives wheels using torque provided by an internal combustion engine instead of, or in addition to, the electric machine 18. This disclosure is not limited to the electrified vehicle 10 of FIG. 1 and the teachings of this disclosure could apply to, among other things, any electrified vehicle that includes a charging port. Further, while a sedan is shown in FIG. 1, this disclosure extends to other types of vehicles such as trucks, vans, sport utility vehicles (SUVs), sedans, sports cars, etc.

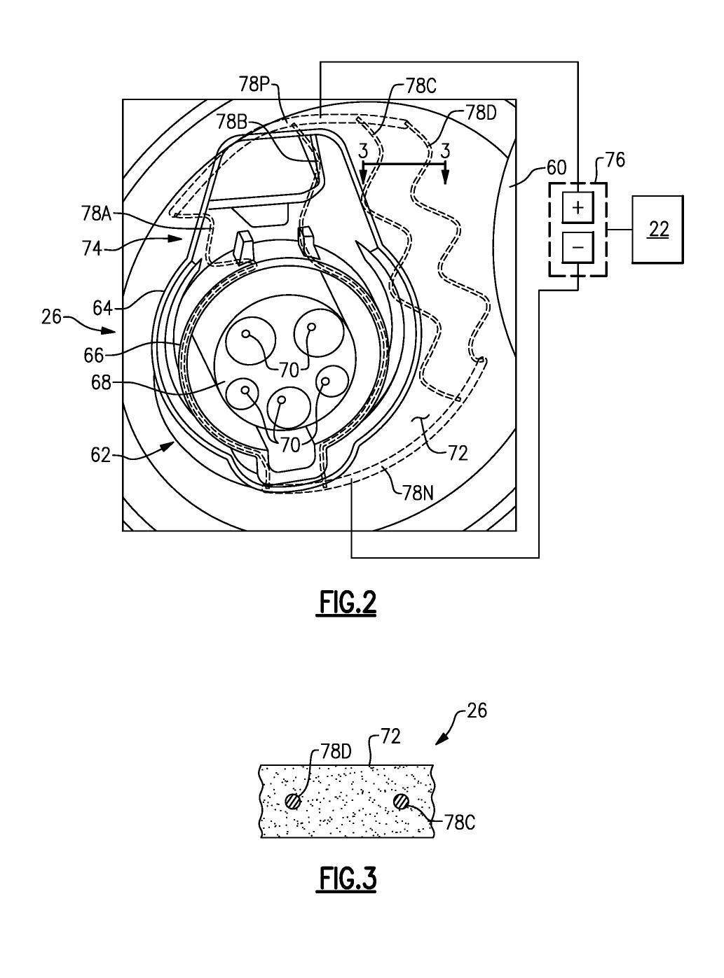

FIG. 2 is a close-up view of the charging port 26. In FIG. 2, the plug 50 is removed from the charging port 26, and a cover 60 is opened for ease of reference. With the cover 60 open, a socket 62 of the charging port 26 is exposed. The socket 62 is configured to receive the plug 50 to electrically couple the grid power source 46 to the battery 14. The socket 62 may have a configuration corresponding to that of the plug 50, such as SAE J1772 or another similar configuration.

The socket 62 includes a first wall 64, which corresponds to the outer profile of the plug 50. Within the first wall 64, the socket 62 includes a second wall 66, which in this example is cylindrical. Within the second wall 66, the socket 62 includes a pin section 68 surrounding a plurality of pins 70. The pin section 68 is concentric with the second wall 66 in this example.

Adjacent the socket 62, the charging port 26 includes an exterior surface 72. The exterior surface 72 is directly exposed to the elements when the cover 60 is open. In this example, at least a portion of the socket 62 is integrally formed with the exterior surface 72. That is, at least a portion of the socket 62 and the exterior surface 72 are formed of the same material, such as a polymer, and during a single manufacturing step, such as injection molding. In one particular example, at least the second wall 66 is integrally formed with the exterior surface 72.

In this disclosure, the charging port 26 includes a heater element 74. The heater element 74 is electrically coupled to a current source 76, which is electrically coupled to the controller 22. The current source 76 is responsive to instructions from the controller 22 to selectively activate the heater element 74. An example control scheme will be discussed below.

The heater element 74, in one example, includes at least one resistive heater wire. In a further example, the heater element 74 includes a plurality of resistive heater wires. In one particular example, which is illustrated in FIG. 2, the heater element 74 includes four resistive heater wires 78A-78D. The resistive heater wires 78A-78D may be made of an electrically conductive material that also creates enough resistance to generate heat, such as nichrome (NiCr). The resistive heater wires 78A-78D are spaced-apart from one another, and are arranged in parallel relative to one another.

The resistive heater wires 78A-78D are coupled to the current source 76 via a positive end 78P and a negative end 78N. The current source 76 could be a high voltage battery, a low voltage battery, or an external power source. When commanded by the controller 22, the current source 76 passes current through the resistive heater wires 78A-78D, which causes the heater element 74 to generate heat. The heat generated by the heater element 74 is used to prevent the accumulation of ice or snow adjacent the charging port 26, or to melt the same if already present.

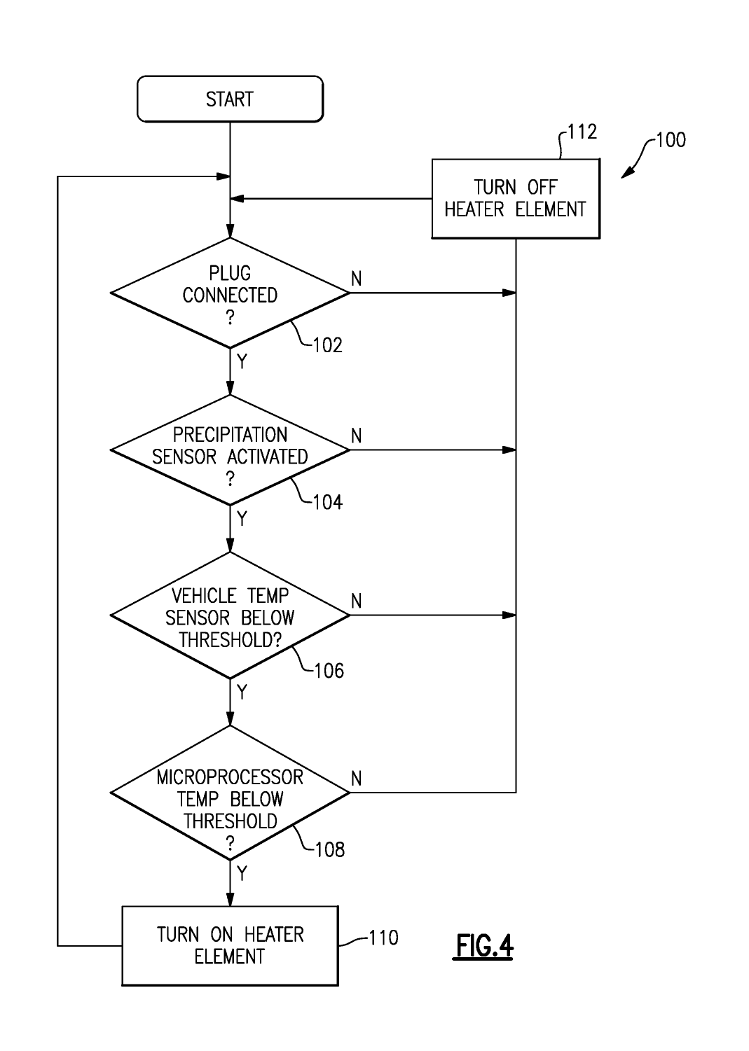

The heater element 74 is at least partially insert-molded with the charging port 26. Insert-molding is the process of molding or forming a part around another part. In this example, the resistive heater wires 78A-78D provide an insert, and at least a portion of the socket 62 and the exterior surface 72 are molded around the resistive heater wires 78A-78D. In one example, the socket 62 and the exterior surface 72 are injection molded around the resistive heater wires 78A-78D. In one particular example, the injection molded material completely encases the resistive wires, as illustrated in FIG. 3. In another example, the injection molded material covers only an exterior of the resistive heater wires 78A-78D, such that the resistive heater wires 78A-78D are arranged beneath the exterior surface 72.

The heater element 74 is arranged to spread heat evenly throughout the exterior surface 72, while also providing localized heat adjacent the socket 62. In order to heat the socket 62, at least one resistive heater wire is at least partially insert-molded into the socket 62. In the illustrated example, a first resistive heater wire 78A is partially insert-molded into a section of the second wall 64, and a second resistive heater wire 78B is partially insert-molded into another section of the second wall 64.

The heater element 74 essentially provides a grid heater element. While a plurality of spaced-apart wires 78A-78D are shown in FIG. 2, other configurations are contemplated. For example, the heater element 74 could be provided by a single, meandering wire.

In one example, in order to better-conduct the heat generated by the heater element 74, the charging port 26 is made of a thermally conductive polymer material. In particular, the exterior surface 72 and at least some portions of the socket 62 are formed of the thermally conductive polymer material. In a specific example, the exterior surface 72, the first wall 64, and the second wall 64 are integrally formed of the thermally conductive polymer material.

The thermally conductive polymer has a thermal conductivity of greater than about 10 watts per meter-Kelvin (W/m-K). In a particular example, the thermally conductive polymer has a thermal conductivity of about 14 W/m-K. These values are in stark contrast to the thermal conductivity of ordinary polymer materials, which are typically around 0.5 W/m-K or less. One known thermally conductive polymer is CoolPoly®, made commercially available by Celanese Corporation.

Forming the charging port 26 by molding over the resistive heater wires 78A-78B with a thermally conductive polymer readily conducts the heat generated by the resistive heater wires 78A-78B throughout the charging port 26 and to the adjacent components. For example, when one connects the plug 50 to the charging port 26, heat is conducted to the plug 50 and its handle. Thus, when charging the electrified vehicle 10 outside during wintery conditions, for example, accumulation of ice or snow is prevented not only on the charging port 26 but also on the plug 50 and its handle. To this end, one example control scheme will now be described.

FIG. 4 is a flow chart representative of a method 100 of this disclosure. The method 100 is an example control scheme in which the controller 22 selectively activates the heater element 74 when conditions are such that ice or snow is likely to form adjacent the charging port 26. It should be understood that the method 100 will be performed by the controller 22 and other components of the electrified vehicle 10, such as those discussed above relative to FIGS. 1-3. Further, while one example method 100 is described, it should be understood that a user-override is contemplated in this disclosure. That is, the user may intervene and manually turn the heater element 74 on or off, as desired, thereby overriding the method 100. In one example, control of the heater element 74 is accomplished via one or more buttons in the infotainment system of the electrified vehicle 10.

The method 100 begins, at 102, with the controller 22 determining whether the plug 50 is electrically coupled to the charging port 26. In one example, when the plug 50 is not connected to the charging port 26, there is no need to activate the heater element 74. In another example, step 102 is replaced by a determination of whether the cover 60 is open. Sometimes, the cover 60 is inadvertently left open for a long period of time, and heating may be beneficial during those times even though the plug 50 is not coupled to the charging port 26.

With continued reference to FIG. 4, the controller 22 next determines whether a precipitation sensor of the electrified vehicle 10 is activated, at 104. The precipitation sensor may be referred to colloquially as a rain sensor, and, generally speaking, is configured to generate a signal indicative of whether rain is falling or whether a humidity is above a certain level. The precipitation sensor may be any known type of precipitation sensor, such as those used to control automatic windshield wipers. The signal from the precipitation sensor is also indicative of whether snow is falling. If the controller 22 determines that neither rain nor snow is falling (i.e., the precipitation sensor is not activated), then the heater element 74 will not be activated.

If, however, the controller 22 determines that rain or snow is falling (i.e., the precipitation sensor is activated), then the method 100 continues by determining whether the temperature justifies operation of the heater element 74. In one example, the controller 22 determines a temperature by considering an output of a vehicle body temperature sensor, at 106. The vehicle body temperature sensor may be any known type of sensor on the electrified vehicle 10 configured to detect the ambient temperature conditions outside the vehicle. If the output of the vehicle body temperature sensor is below a predetermined threshold, such as 40° F. (about 4° C.), then the method 100 continues. If not, the controller determines that activation of the heater element 74 is not necessary.

Alternatively or in addition to step 106, the controller 22 may consider a temperature reading from a microprocessor associated with the charging port 26, at 108. Charging ports 26 are known to include multiple electronic components, such as lights (i.e., a light ring provided circumferentially about the charging port 26), status bars, etc., and those components include microprocessors. The controller 22 may receive a signal indicative of a temperature of one such component. If that temperature is below a predetermined threshold, such as 75° F. (about 24° C.), then the controller 22 activates (i.e., turns on) the heater element 74, at 110. The method 100 repeats these steps, and the controller 22 is capable of deactivating (i.e., turning off) the heater element 74, at 112, as necessary. Using the temperature reading from an existing microprocessor may provide temperature information that closely approximates the conditions adjacent the charging port 26 while also reducing cost.

It should be understood that terms such as “about,” “substantially,” and “generally” are not intended to be boundaryless terms, and should be interpreted consistent with the way one skilled in the art would interpret those terms. Further, directional terms such as “exterior,” “inward,” etc., are used for purposes of explanation only and should not otherwise be construed as limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. An electrified vehicle, comprising:
a charging port having a heater element at least partially insert-molded with the charging port.

2. The electrified vehicle as recited in claim 1, wherein the charging port includes a polymer material molded over the heater element.

3. The electrified vehicle as recited in claim 2, wherein the polymer has a thermal conductivity of greater than about 10 watts per meter-Kelvin (W/m-K).

4. The electrified vehicle as recited in claim 3, wherein the polymer has a thermal conductivity of about 14 watts per meter-Kelvin (W/m-K).

5. The electrified vehicle as recited in claim 1, wherein the heater element includes at least one resistive heater wire.

6. The electrified vehicle as recited in claim 5, wherein the at least one resistive heater wire is at least partially insert-molded into a socket of the charging port.

7. The electrified vehicle as recited in claim 5, wherein the heater element includes a plurality of resistive heater wires, each of the plurality of resistive heater wires spaced-apart from one another.

8. The electrified vehicle as recited in claim 7, wherein each of the plurality of resistive heater wires are arranged in parallel relative to one another.

9. The electrified vehicle as recited in claim 7, wherein each of the plurality of resistive heater wires are arranged beneath an exterior surface of the charging port.

10. The electrified vehicle as recited in claim 7, wherein two of the plurality of resistive heater wires are at least partially insert-molded into a socket of the charging port.

11. The electrified vehicle as recited in claim 1, further comprising:
a controller; and
a current source electrically coupled to the controller and to the heater element, the current source responsive to instructions from the controller to selectively activate the heater element.

12. An electrified vehicle, comprising:
a charging port having a heater element, the charging port including a polymer having a thermal conductivity of greater than about 10 watts per meter-Kelvin (W/m-K).

13. The electrified vehicle as recited in claim 12, wherein the polymer has a thermal conductivity of about 14 watts per meter-Kelvin (W/m-K).

14. The electrified vehicle as recited in claim 12, wherein the heater element includes at least one resistive heater wire insert-molded into the charging port.

15. The electrified vehicle as recited in claim 14, wherein the at least one resistive heater wire is at least partially insert-molded into a socket of the charging port.

16. A method, comprising:
heating a charging port of an electrified vehicle by activating a heater element insert-molded into the charging port.

17. The method as recited in claim 16, wherein:
the charging port includes a polymer molded over the heater element,
the polymer has a thermal conductivity of greater than about 10 watts per meter-Kelvin (W/m-K), and
when a plug is coupled to the charging port, the heater element heats the plug via the charging port.

18. The method as recited in claim 16, wherein the step of heating the charging port is performed only when a precipitation sensor is activated.

19. The method as recited in claim 16, wherein the step of heating the charging port is performed only when a temperature falls below a predetermined threshold.

20. The method as recited in claim 19, wherein the temperature is determined based on an output from at least one of a vehicle body temperature sensor and a microprocessor adjacent the charging port.
